(19) United States
(12) Patent Application Publication
(10) Pub. No.: US 2019/0056679 A1
(43) Pub. Date: Feb. 21, 2019

(54) ELECTROSTATIC LATENT IMAGE DEVELOPING TONER AND TWO-COMPONENT DEVELOPER

(71) Applicant: Konica Minolta, Inc., Tokyo (JP)

(72) Inventors: Junya UEDA, Tokyo (JP); Satoshi UCHINO, Tokyo (JP); Shinya OBARA, Tokyo (JP); Takuya TAKAHASHI, Tokyo (JP)

(21) Appl. No.: 16/104,534

(22) Filed: Aug. 17, 2018

(30) Foreign Application Priority Data
Aug. 21, 2017 (JP) 2017-158397

(51) Int. Cl. G03G 9/097; G03G 9/113; G03G 9/087

(52) U.S. Cl. CPC G03G 9/09725; G03G 9/08755; G03G 9/08711; G03G 9/1133

(57) ABSTRACT

An electrostatic latent image developing toner includes toner particles having silica particles as an external additive on surfaces of toner base particles, wherein surfaces of a part or all of the silica particles are modified with silicone oil, and the following relational formula (1) is satisfied.

0.30≤Si(B)/Si(A)≤0.65 relational formula (1)

[In the relational formula (1), Si(A) represents a NET intensity of a Si element contained in the electrostatic latent image developing toner, measured by a wavelength dispersive X-ray fluorescence analyzer. Si(B) represents a NET intensity of a Si element contained in the electrostatic latent image developing toner ultrasonically dispersed in water, measured by a wavelength dispersive X-ray fluorescence analyzer.]

The entire disclosure of Japanese patent Application No. 2017-158397, filed on Aug. 21, 2017, is incorporated herein by reference in its entirety.

### BACKGROUND

### Technological Field

The present invention relates to an electrostatic latent image developing toner and a two-component developer. More specifically, the present invention relates to an electrostatic latent image developing toner having good graininess of a printed image even after printing is performed continuously at a low printing rate and capable of suppressing cleaning failure over a long period of time, and the like.

### Description of the Related Art

Examples of performance required for an electrostatic latent image developing toner (hereinafter also simply referred to as a “toner”) used for electrophotographic image formation include chargeability, fluidity, transferability, and cleaning performance (hereinafter also referred to as “CL performance”).

Conventionally, in order to impart or improve these characteristics, particles formed of various organic compounds and inorganic compounds, referred to as an external additive, are added to the toner. For example, it is known that inorganic particles containing silica, titanium oxide, or the like are added (for example, see JP 2015-94875 A or JP 2010-217588 A).

Among the particles, in order to ensure cleaning performance and transferability of a toner, for example, particles containing silica having surfaces modified with silicone oil (hereinafter also referred to simply as “silica particles”) are used (for example, see JP 8-248674 A or JP 2002-174926 A).

The silica particles having surfaces modified with silicone oil enhance lubricity of a toner or an external additive that has entered a nip portion between a cleaning blade and an electrostatic latent image carrier, reduce a friction coefficient between the blade and the electrostatic latent image carrier, can suppress wear of the cleaning blade, and as a result, can improve cleaning performance.

In addition, when the external additive includes silicone oil that can be appropriately released, a trace amount of the released silicone oil is continuously supplied to the electrostatic latent image carrier all the times, spreads over a surface of the electrostatic latent image carrier in a short time because of low surface energy thereof, and can reduce a friction coefficient of the latent image carrier. A lot of toner usually adheres to an edge portion, a central portion, or the like in a character portion, a line portion, and a dot portion. When such a portion to which a large amount of toner adheres is compressed by a transfer material, adhesion to a photoreceptor is enhanced. When the toner cannot move in a transfer electric field as a result of an increase in adhesion to a photoreceptor, the toner cannot be transferred. As a result, image failure (so-called “transfer missing”) occurs. However, when appropriately released silicone oil is present, adhesion to the photoreceptor decreases, and it is considered that transfer missing does not occur even if the toner is strongly compressed by the transfer material.

However, when released silicone oil is present, in a case where printing is performed continuously at a low printing rate (for example, 3%), silica particles having surfaces modified with silicone oil are buried in base particles of the toner or unevenly distributed due to stress, and the released silicone oil thereby moves to surfaces of another external additive (for example, silica particles having surfaces not modified with silicone oil) or the toner base particles. As a result, aggregation of the toner particles occurs, transferability is deteriorated, and graininess deteriorates as image quality disadvantageously.

### SUMMARY

The present invention has been achieved in view of the above problems and circumstances, and an object of the present invention is to provide an electrostatic latent image developing toner and a two-component developer having good graininess of a printed image even after printing is performed continuously at a low printing rate and capable of suppressing cleaning failure over a long period of time.

To achieve the abovementioned object, according to an aspect of the present invention, an electrostatic latent image developing toner reflecting one aspect of the present invention comprises toner particles having silica particles as an external additive on surfaces of toner base particles, wherein surfaces of a part or all of the silica particles are modified with silicone oil, and the following relational formula (1) is satisfied.

0.30≤Si(B)/Si(A)≤0.65 relational formula (1)

[In the relational formula (1), Si(A) represents a NET intensity of a Si element contained in the electrostatic latent image developing loner, measured by a wavelength dispersive X-ray fluorescence analyzer. Si(B) represents a NET intensity of a Si element contained in the electrostatic latent image developing toner ultrasonically dispersed in water, measured by a wavelength dispersive X-ray fluorescence analyzer.]

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an example of an image forming device.

### DETAILED DESCRIPTION OF EMBODIMENTS

Hereinafter, one or more embodiments of the present invention will be described with reference to the drawings. However, the scope of the invention is not limited to the disclosed embodiments.

An electrostatic latent image developing toner according to an embodiment of the present invention is an electrostatic latent image developing toner containing toner particles having silica particles as an external additive on surfaces of toner base particles, characterized in that surfaces of a part or all of the silica particles are modified with silicone oil, and the relational formula (1) is satisfied. This characteristic is a technical characteristic common or corresponding to inventions according to embodiments. Therefore, according to an embodiment of the present invention, a printed image has good graininess even after printing is performed continuously at a low printing rate, and cleaning failure can be suppressed over a long period of time.

As a mode of the present invention, the Si(A) and the Si(B) preferably satisfy the relational formula (2). An effect of the present invention can be thereby exhibited more suitably.

As a mode of the present invention, the content of the silica particles having surfaces modified with the silicone oil is preferably in a range of 0.3 to 1.0% by mass relative to 100% by mass of the electrostatic latent image developing toner. Initial transferability can be thereby improved.

As a mode of the present invention, a release ratio of the silicone oil from the silica particles is preferably in a range of 30 to 70% by mass. Cleaning performance after long-term continuous printing can be maintained more favorably.

As a mode of the present invention, the electrostatic latent image developing toner according to any one of claims 1 to 4 and a carrier coated with a resin formed by polymerizing at least an alicyclic methacrylate monomer are preferably contained. Mechanical strength and environmental stability of a charge amount can be thereby made more suitable, and an effect of the present invention can be exhibited more suitably.

Hereinafter, the present invention, constituent elements thereof, and embodiments and modes for performing the present invention will be described in detail. Incidentally, in the present application. “to” means inclusion of numerical values described before and after “to” as a lower limit value and an upper limit value.

Incidentally, in the present invention, a primary particle diameter means a particle diameter of a primary particle, and the primary particle refers to an independent particle without aggregation.

In the present invention, “toner” means an aggregate of“toner particles”.

The toner particles mean “particles having an external additive on surfaces of toner base particles”.

<<Outline of Electrostatic Latent Image Developing Toner>>

An electrostatic latent image developing toner according to an embodiment of the present invention is an electrostatic latent image developing toner containing toner particles having silica particles as an external additive on surfaces of toner base particles, in which

surfaces of a part or all of the silica particles are modified with silicone oil, and

the following relational formula (1) is satisfied.

0.30≤Si(B)/Si(A)≤0.65 relational formula (1)

[In the relational formula (1), Si(A) represents a NET intensity of a Si element contained in the electrostatic latent image developing toner, measured by a wavelength dispersive X-ray fluorescence analyzer. Si(B) represents a NET intensity of a Si element contained in the electrostatic latent image developing toner ultrasonically dispersed in water, measured by a wavelength dispersive X-ray fluorescence analyzer.]

In the toner according to an embodiment of the present invention, Si(A) and Si(B) preferably satisfy the following relational formula (2) because an effect of the present invention can be more suitably exhibited.

0.35≤Si(B)/Si(A)≤0.60 relational formula (2)

<Method for Measuring NET Intensity (Si(A) and Si(B)) of Si Element>

Si(A) and Si(B) according to an embodiment of the present invention are calculated from a NET intensity ratio of Si by wavelength dispersive X-ray fluorescence spectroscopy (WDXRF) before and after a toner in a toner bottle is ultrasonically dispersed in water.

(Method for Obtaining Toner Ultrasonically Dispersed in Water)

In a 100 mL plastic cup, 3 g of toner is wetted in 40 g of a 0.2% by mass polyoxyethyl phenyl ether aqueous solution. Using an ultrasonic homogenizer “US-1200” (manufactured by Nippon Seiki Co., Ltd.), ultrasonic energy is applied to the solution for three minutes by making adjustment such that a value of an ammeter indicating a vibration indication value attached to a main body of the homogenizer indicates 60 μA (50 W). Thereafter, the aqueous solution in which the toner is dispersed is centrifuged and separated under conditions of 292 G and 10 minutes.

Used centrifuge: Model H-900 manufactured by Kokusan Co. Ltd.

Rotor PC-400 (radius 18.1 cm)

Rotation speed: 1200 rpm (292 G)

Time: 15 minutes

After centrifugation, the supernatant is discarded. The remainder is mixed with 60 mL of pure water again, filtered using a filter having an opening of 1 μm, washed with 60 mL of pure water, and collected. The collected product is mixed with 60 mL of pure water again, filtered using a filter having an opening of 1 μm, washed with 60 mL of pure water, collected, and dried.

(Method for Measuring NET Intensity)

A method for measuring a NET intensity of Si contained in the “toner according to an embodiment of the present invention” (not ultrasonically dispersed in water) and the “toner ultrasonically dispersed in water according to an embodiment of the present invention” is as follows.

The NET intensity of a metallic element Si contained in the toner can be measured using a known wavelength dispersive X-ray fluorescence analyzer (hereinafter also referred to simply as “X-ray fluorescence analyzer”), for example, using XRF-1700 (manufactured by Shimazu Corporation). Specifically, 3 g of a sample pressurized and pelletized is set in the X-ray fluorescence analyzer and measurement is performed under measurement conditions of a tube voltage of 40 kV, a tube current of 90 mA, a scanning speed of 8 deg./min, and a step angle of 0.1 deg. For measurement, a Kα peak angle of a metallic element to be measured is determined from a 20 Table and used.

[Toner Particles]

The toner particles according to an embodiment of the present invention have silica particles as an external additive on surfaces of the toner base particles.

<Silica Particles>

Surfaces of a part or all of the silica particles according to an embodiment of the present invention are modified with silicone oil.

Here, the phrase “surfaces of a part of the silica particles are modified with silicone oil” means that the silica particles contained in the toner constitute two kinds of particle groups consisting of a silica particle group having surfaces modified with silicone oil and a silica particle (for example, large diameter silica described below) group having surfaces not modified with silicone oil. In addition, the phrase “surfaces of all of the silica particles are modified with silicone oil” means that all of the silica particles contained in the toner are modified with silicone oil.

Incidentally, as a mode of modifying surfaces of the silica particles with silicone oil, modifying may be performed so as to coat the entire surfaces of the silica particles, or modifying may be performed so as to coat a part of the surfaces of the silica particles as long as exhibition of an effect of the present invention is not impaired.

(Method for Modifying Surface with Silicone Oil)

Silica particles before the surfaces thereof are modified with silicone oil can be manufactured by a known method. Examples of a method for manufacturing silica particles include a method for hydrolyzing an alkoxysilane (sol-gel method), a method for vaporizing a silicon chloride to synthesize silica particles by a gas phase reaction in high temperature hydrogen flame (gas phase method or gas combustion method), and a method for heating a mixed raw material containing finely pulverized quartz silica, a reducing agent such as metallic silicone powder or carbon powder, and water for forming slurry at a high temperature in a reducing atmosphere to generate SiO gas and cooling the SiO gas in an atmosphere containing oxygen (melting method). The method for manufacturing silica particles is preferably a sol-gel method from a viewpoint that particles having a narrow particle diameter distribution are easily obtained to make it possible to suppress variations in adhesion strength of an external additive to the toner base particles.

Therefore, a method for manufacturing silica particles by a sol-gel method will be described below.

Specifically, first, tetrannethoxysilane (TMOS) is added to pure water to prepare a TMOS hydrolysis solution. Subsequently, the TMOS hydrolysis solution is added to a mixed solution with an alkali catalyst at a predetermined rate. Thereafter, the alkali catalyst is appropriately added thereto while the pH is adjusted, and the TMOS hydrolysis solution is added thereto at the predetermined rate at regular time intervals. This operation is continued. Thereafter, hydrolysis and condensation are performed, and a mixed medium dispersion of hydrophilic spherical silica particles can be thereby obtained. Here, the particle diameter (number average primary particle diameter) and the average circularity of obtained silica particles can be controlled by changing the addition amount of the alkali catalyst (addition amount to TMOS) or the addition rate of the TMOS hydrolysis solution. If the addition rate of the TMOS hydrolysis solution is increased, the particle diameters of the silica particles are increased.

The alkali catalyst used in the sol-gel method is not particularly limited, but examples thereof include ammonia; urea; a monoamine compound such as trimethylamine, triethylamine, or dimethylethylamine; a diamine compound such as ethylenediamine, tetramethyl ethylenediamine, tetramethyl propylenediamine, or tetramethyl butylenediamine; and a quaternary ammonium salt.

The number average primary particle diameter of the silica particles before surface thereof are modified with silicone oil is preferably 5 to 300 nm. Note that a value measured by a method described in Examples is adopted as the number average primary particle diameter. Incidentally, the thickness of silicone oil with which the surfaces are modified is so thin as to be negligible with respect to the particle diameter of each of the silica particles, and therefore the number average primary particle diameter of the silica particles before surfaces of which are modified with the silicone oil is almost the same as the number average primary particle diameter of the silica particles after surfaces of which are modified with the silicone oil.

The average circularity of the silica particles before surfaces of which are modified with silicone oil is not particularly limited, but is preferably in a range of 0.730 to 0.980, more preferably in a range of 0.750 to 0.950, and particularly preferably in a range of 0.800 to 0.945. Note that a value measured by a method described in Examples is adopted as the average circularity.

As the silicone oil with which surfaces of the silica particles are modified, known silicone oil can be used. Examples of the silicone oil include dimethyl silicone oil, alkyl-modified silicone oil, amino-modified silicone oil, carboxyl-modified silicone oil, epoxy-modified silicone oil, fluorine-modified silicone oil, alcohol-modified silicone oil, polyether-modified silicone oil, methylphenyl silicone oil, methyl hydrogen silicone oil, mercapto-modified silicone oil, higher fatty acid-modified silicone oil, phenol-modified silicone oil, methacrylic acid-modified silicone oil, polyether-modified silicone oil, and methylstyryl-modified silicone oil.

The silicone oil used for modifying a surface may be used singly or in combination of two or more kinds thereof as long as exhibition of an effect of the present invention is not impaired. Among these oils, the silicone oil is preferably dimethyl silicone oil from viewpoints of cost and ease of handling. The dimethyl silicone oil preferably has a kinematic viscosity of 10 to 100 mm²/s at 25° C.

Note that the silica particles may be subjected to hydrophobic treatment with an organic compound, a silane coupling agent, or the like before the surfaces thereof are modified with silicone oil.

Examples of a method for modifying the surfaces with silicone oil include a dry method such as a spray dry method for spraying a treating agent or a solution containing a treating agent onto particles floating in a gas phase, a wet method for immersing particles in a solution containing a treating agent and drying the particles, and a mixing method for mixing a treating agent and particles with a mixer.

By removing a solvent from silica sol having surfaces modified with silicone oil and drying the resulting product, silica particles having surfaces modified with silicone oil can be obtained. By heating the resulting silica particles having surfaces modified with silicone oil at 100° C. to several hundreds of degrees, a siloxane bond between the silica particles and the silicone oil can be formed using a hydroxy group on surfaces of the silica particles, or the silicone oil itself can be further polymerized or crosslinked. By adding a catalyst such as an acid, an alkali, a metal salt, zinc octylate, tin octylate, or dibutyltin dilaurate to the silicone oil in advance, a reaction may be accelerated. In addition, by immersing the silica particles in a solvent such as ethanol again, the silicone oil which has been used for excessive treatment may be removed.

The number average primary particle diameter of the silica particles having surfaces treated with silicone oil is preferably 5 to 300 nm, and more preferably 20 to 200 nm. The number average primary particle diameter is more preferably 30 to 200 nm, still more preferably 30 to 150 nm, and particularly preferably 30 to 90 nm. By setting the particle diameter of each of the silica particles having surfaces treated with silicone oil to 20 nm or more, silica particles hardly move on surfaces of the toner base particles, and released silicone oil hardly adheres to a toner surface or another external additive. Therefore, transferability is improved. By setting the particle diameter of each of the silica particles having surfaces treated with silicone oil to 200 nm or less, the silica particles having surfaces treated with silicone oil easily adhere to surfaces of the toner base particles, and cleaning performance is further improved.

As the number average primary particle diameter of the silica particles having surfaces treated with silicone oil, a value measured by a similar method to a method for measuring the number average primary particle diameter of silica particles described in Examples is adopted.

Incidentally, the thickness of the silicone oil with which the surfaces of the silica particles are modified is extremely small with respect to the particle diameter of each of the silica particles, and therefore the particle diameter of each of the silica particles having surfaces treated with the silicone oil can be controlled by changing the particle diameters of the silica particles.

As a mode of the present invention, the content of the silica particles having surfaces modified with the silicone oil is preferably in a range of 0.3 to 1.0% by mass relative to 100% by mass of the electrostatic latent image developing toner. With the content of 0.3% by mass or more, performance of the silica particles having surfaces modified with silicone oil can be exhibited. With the content of 1.0% by mass or less, toner aggregation due to silicone oil can be suppressed, and therefore initial transferability is good.

(Release Ratio of Silicone Oil)

A release ratio of the silicone oil from the silica particles is preferably in a range of 20 to 95% by mass, and more preferably in a range of 30 to 70% by mass.

Reasons therefor are as follows. That is, with the content of 20% by mass or more, only the silicone oil accumulated on a photoconductor can be polished more appropriately, and therefore cleaning performance can be maintained favorably even after printing is performed for a long period of time. With the content of 95% by mass or less, the silicone oil is appropriately supplied to the photoreceptor, and therefore transferability can be improved. The release ratio of the silicone oil is more preferably in a range of 30 to 70% by mass from such a viewpoint.

(Method for Measuring Release Ratio of Silicone Oil)

The release ratio of silicone oil can be measured by the following quantitative methods (1) to (3).

(1) Operation of Extracting Released Silicone Oil

A sample (that is, toner) for extracting released silicone oil is immersed in chloroform, stirred, and then allowed to stand.

Subsequently, chloroform is newly added to a solid obtained by removing the supernatant by centrifugation. The resulting mixture is stirred and then allowed to stand.

This operation is repeated to remove released silicone oil.

(2) Quantitative Determination of Content of Carbon

The content of carbon in a sample before the extraction operation and the content of carbon in the sample after the extraction operation are measured with a CHN element analyzer (for example, CHN coder MT-5 type (manufactured by Yanaco Group)).

(3) Calculation of Release Ratio of Silicone Oil

The release ratio of silicone oil was determined by the following formula.

Release ratio of silicone oil=(C₀−C₁)/C₀×100(%)

[In the above formula,

C₀: content of carbon in sample before extraction operation

C₁: content of carbon in sample after extraction operation]

<Toner Base Particles>

The toner base particles according to an embodiment of the present invention are not particularly limited, and for example, known particles can be used.

Specifically, for example, the toner base particles according to an embodiment of the present invention may contain a binder resin, and may further contain another component such as a colorant, a release agent (wax), or a charge control agent, if necessary.

Specific examples of the binder resin, the colorant, the charge control agent, and the release agent that can be contained in the toner base particles according to an embodiment of the present invention will be described below.

<Binder Resin>

The binder resin contained in the toner base particles according to an embodiment of the present invention preferably contains an amorphous resin together with a crystalline resin.

The binder resin used in the present invention is not particularly limited, and details thereof will be described below. Suitable examples thereof include an amorphous resins and a crystalline resin described in paragraphs 0065 to 0106 of JP 2017-021192 A, and a hybrid crystalline polyester resin containing a styrene-acrylic resin as a unit as described in paragraphs 0027 to 0075 of JP 2016-161780 A.

(Amorphous Resin)

The amorphous resin according to an embodiment of the present invention does not have a melting point and has a relatively high glass transition temperature (Tg) when the resin is subjected to differential scanning calorimetry (DSC). The glass transition temperature (Tg) of the amorphous resin is not particularly limited, but is (Ser. No. 00/086,408) 7 preferably 25 to 60° C. from a viewpoint of reliably obtaining fixability such as low-temperature fixability and heat resistance such as a heat-resistant storage property or blocking resistance.

(Method for Measuring Glass Transition Temperature)

The glass transition temperature Tg can be determined using a differential scanning calorimeter “Diamond DSC” (manufactured by Perkin Elmer Inc.). As measurement conditions, Heat-cool-Heat temperature control is performed at a measurement temperature of 0 to 150° C., a temperature-rising rate of 10° C./min, and a temperature-falling rate of 10° C./min. analysis is performed based on data at the second Heat, an extension line of a base line before rise of a first endothermic peak and a tangent line indicating a maximum inclination from a rising portion of the first peak to a peak apex are drawn, and the temperature of the intersection of these lines can be defined as the glass transition temperature Tg.

The amorphous resin is not particularly limited as long as having the above characteristics, and a conventionally known amorphous resin in the present technical field can be used. Specific examples thereof include a vinyl resin, a urethane resin, and a urea resin. Among these resins, a vinyl resin is preferable because of easy control of thermoplasticity.

The vinyl resin is not particularly limited as long as being obtained by polymerizing a vinyl compound, and examples thereof include a (meth)acrylate resin, a styrene-(meth)acrylate resin, and an ethylene-vinyl acetate resin. These resins may be used singly or in combination of two or more kinds thereof.

Among the above vinyl resins, a styrene-(meth)acrylate resin is preferable in consideration of plasticity at the time of thermal fixing. Hereinafter, a styrene-(meth)acrylate resin (hereinafter also referred to as “styrene-(meth)acrylic resin”) as an amorphous resin will be described.

The styrene-(meth)acrylic resin is formed by addition polymerization of at least a styrene monomer and a (meth)acrylate monomer. The styrene monomer referred to herein includes, in addition to styrene represented by the structural formula of CH₂═CH—C₆H₅, a compound having a known side chain or functional group in a styrene structure. In addition, the (meth)acrylate monomer referred to herein includes, in addition to an acrylate and a methacrylate represented by CH₂═CHCOOR (R represents an alkyl group), an ester having a known side chain or functional group in a structure such as an acrylate derivative or a methacrylate derivative. Note that, here, the “(meth)acylate monomer” is a generic name of an “acrylate monomer” and a “methacrylate monomer”.

Examples of a styrene monomer and a (meth)acrylate monomer capable of forming a styrene-(meth)acrylic resin are illustrated below.

Specific examples of the styrene monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene. These styrene monomers can be used singly or in combination of two or more kinds thereof.

Specific examples of the (meth)acrylate monomer include an acrylate monomer such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, or phenyl acrylate; and a methacylate monomer such as methyl methacrylate, ethyl methacrylate, n-butyl methacrylate, isopropyl methacrylate, isobutyl methacrylate, t-butyl methacylate, n-octyl methacrylate, 2-ethylhexyl methacrylate, stearyl methacrylate, lauryl methacrylate, phenyl methacrylate, diethylaminoethyl methacrylate, or dimethylaminoethyl methacrylate. These (meth)acrylate monomers can be used singly or in combination of two or more kinds thereof.

The content of a constitutional unit derived from a styrene monomer in the styrene-(meth)acrylic resin is preferably 40 to 90% by mass relative to the total amount of the resin. The content of a constitutional unit derived from a (meth)acrylate monomer in the resin is preferably 10 to 60% by mass relative to the total amount of the resin.

Furthermore, the styrene-(meth)acrylic resin may contain, in addition to the styrene monomer and the (meth)acrylate monomer, the following monomer compounds.

Examples of such a monomer compound include a compound having a carboxy group, such as acrylic acid, methacrylic acid, maleic acid, itaconic acid, cinnamic acid, fumaric acid, a maleic acid monoalkyl ester, or an itaconic acid monoalkyl ester; and a compound having a hydroxy group, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, or 4-hydroxybutyl (meth)acrylate. These monomer compounds can be used singly or in combination of two or more kinds thereof.

The content of a constitutional unit derived from the monomer compound in the styrene-(meth)acrylic resin is preferably 0.5 to 20% by mass relative to the total amount of the resin.

The styrene-(meth)acrylic resin preferably has a weight average molecular weight (Mw) of 10,000 to 100,000. A method for manufacturing the styrene-(meth)acrylic resin is not particularly limited, and examples thereof include a method for performing polymerization using any polymerization initiator such as a peroxide, a persulfide, a persulfate, or an azo compound usually used for polymerization of the above monomers by a known polymerization method such as block polymerization, solution polymerization, an emulsion polymerization method, a miniemulsion method, or a dispersion polymerization method. In addition, in order to adjust the molecular weight, a generally used chain transfer agent can be used. The chain transfer agent is not particularly limited, and examples thereof include an alkyl mercaptan such as n-octyl mercaptan and a mercapto fatty acid ester.

The content of the amorphous resin in the binder resin is not particularly limited, but is preferably more than 50% by mass, more preferably 70% by mass or more, and particularly preferably 90% by mass or more relative to the total amount of the binder resin. Meanwhile, an upper limit value of the content is not particularly limited, and is 100% by mass or less.

(Method for Manufacturing Amorphous Resin)

The amorphous resin is preferably manufactured by an emulsion polymerization method. In the emulsion polymerization, the amorphous resin can be obtained by dispersing and polymerizing a polymerizable monomer (for example, styrene or an acrylate) in an aqueous medium described below. In order to disperse the polymerizable monomer in the aqueous medium, a surfactant is preferably used. For polymerization, a known polymerization initiator and chain transfer agent can be used.

(Polymerization Initiator)

As the polymerization initiator, various known polymerization initiators are suitably used. Specific examples of the polymerization initiator include a peroxide such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethyl benzoyl peroxide, lauroyl peroxide, ammonium persulfate, sodium persulfate, potassium persulfate, diisopropyl peroxycarbonate, di-t-butyl peroxide, tetralin hydroperoxide, 1-phenyl-2-methylpropyl-1-hydroperoxide, pertriphenylacetic acid-tert-butyl-hydroperoxide, tert-butyl performate, tert-butyl peracetate, tert-butyl perbenzoate, tert-butyl perphenylacetate, tert-butyl permethoxyacetate, or tert-butyl N-(3-toluyl) perpalmitate; and an azo compound such as 2,2′-azobis(2-aminodipropane) hydrochloride, 2,2′-azobis(2-aminodipropane) nitrate, 1,1′-azobis(sodium I-methylbutyronitrile-3-sulfonate), 4,4′-azobis-4-cyanovaleric acid, or poly(tetraethylene glycol-2,2′-azobisisobutyrate).

(Chain Transfer Agent)

The chain transfer agent is not particularly limited, and examples thereof include a mercaptan such as octyl mercaptan, dodecyl mercaptan, an alkyl mercaptan, or t-dodecyl mercaptan; a mercaptopropionate such as n-octyl-3-mercaptopropionate or stearyl-3-mercaptopropionate; a mercapto fatty acid ester; and a styrene dimer. These compounds can be used singly or in combination of two or more kinds thereof.

<Crystalline Resin>

Examples of the crystalline resin include a crystalline polyester resin, a crystalline polyurethane resin, a crystalline polyurea resin, a crystalline polyamide resin, and a crystalline polyether resin. A crystalline polyester resin is particularly preferably used.

In the present invention, the crystalline resin has a definite endothermic peak in a DSC curve measured using the above differential scanning calorimeter “Diamond DSC” (manufactured by Perkin Elmer Inc.).

[Crystalline Polyester Resin]

The crystalline polyester resin refers to a resin exhibiting crystallinity among polyester resins obtained by a polymerization reaction between a divalent or higher valent carboxylic acid (polycarboxylic acid) monomer and a divalent or higher valent alcohol (polyhydric alcohol) monomer.

The crystalline polyester resin can be formed in a similar manner to the above-described amorphous polyester resin.

Examples of the polycarboxylic acid monomer that can be used for synthesizing the crystalline polyester resin include a saturated aliphatic dicarboxylic acid such as oxalic acid, malonic acid, succinic acid, adipic acid, sebacic acid, azelaic acid, n-dodecylsuccinic acid 1,10-decanedicarboxylic acid (dodecanedioic acid), or 1,12-dodecanedicarboxylic acid (tetradecanedioic acid); an alicyclic dicarboxylic acid such as cyclohexanedicarboxylic acid; an aromatic dicarboxylic acid such as phthalic acid, isophthalic acid, or terephthalic acid; a trivalent or higher valent polycarboxylic acid such as trimellitic acid or pyromellitic acid; anhydrides of these carboxylic acid compounds; and alkyl esters of these carboxylic acid compounds, having 1 to 3 carbon atoms.

These compounds may be used singly or in combination of two or more kinds thereof.

Examples of the polyhydric alcohol monomer that can be used for synthesizing the crystalline polyester resin include an aliphatic diol such as 1,2-propanediol, 1,3-propanediol, 1,4-butanediol, 1,5-pentanediol, 1,6-hexanediol, 1,7-heptanediol, 1,8-octanediol, 1,9-nonanediol, neopentyl glycol, or 1,4-butenediol; and a trivalent or higher valent polyhydric alcohol such as glycerin, pentaerythritol, trimethylolpropane, or sorbitol.

These compounds may be used singly or in combination of two or more kinds thereof.

(Method for Manufacturing Crystalline Resin)

A method for manufacturing a crystalline resin is not particularly limited, and the crystalline resin can be manufactured by a known method, for example, by mixing polymerizable monomers (for example, polyhydric alcohol monomers or polycarboxylic acid monomers if it is intended to manufacture a crystalline polyester resin) and polymerizing the monomers using a known catalyst such as tin oxide.

<Colorant>

A colorant can be added to the toner according to an embodiment of the present invention. A known colorant can be used as the colorant.

Specific examples of the colorant include carbon black, a magnetic material, a dye, and a pigment. Specific examples of the carbon black include channel black, furnace black, acetylene black, thermal black, and lamp black. Examples of the magnetic material include ferromagnetic metal such as iron, nickel, or cobalt, an alloy containing these metals, and a ferromagnetic metal compound such as ferrite or magnetite.

Examples of the dye include C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, C.I. Solvent Blue 95, and a mixture thereof. Examples of the pigment include C.I. Pigment Red 5, C.I. Pigment Red 48:1, C.I. Pigment Red 48:3, C.I. Pigment Red 53:1, C.I. Pigment Red 57:1, C.I. Pigment Red 81:4, C.I. Pigment Red 122, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, C.I. Pigment Orange 31, C.I. Pigment Orange 43, C.I. Pigment Yellow 14, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 180, C.I. Pigment Yellow 185, C.I. Pigment Green 7, C.I. Pigment Blue 15:3, C.I. Pigment Blue 15:4, C.I. Pigment Blue 60, and a mixture thereof.

Note that the content of the colorant contained in a yellow toner is preferably 1 to 10 parts by mass, and more preferably 2 to 8 parts by mass relative to 100 parts by mass of the binder resin.

The content of the colorant contained in a magenta toner is preferably 1 to 10 parts by mass, and more preferably 2 to 8 parts by mass relative to 100 parts by mass of the binder resin.

The content of the colorant contained in a cyan toner is preferably 1 to 10 parts by mass, and more preferably 2 to 8 parts by mass relative to 100 parts by mass of the binder resin.

The content of the colorant contained in a black toner is preferably 1 to 10 parts by mass, and more preferably 2 to 8 parts by mass relative to 100 parts by mass of the binder resin.

The toner according to an embodiment of the present invention may contain an internal additive such as a charge control agent or a release agent and another external additive, if necessary.

<Charge Control Agent>

As the charge control agent constituting charge control agent particles, various known charge control agents that can be dispersed in an aqueous medium can be used. Specific examples of the charge control agent include a nigrosine-based dye, a metal salt of naphthenic acid or a higher fatty acid, an alkoxylated amine, a quaternary ammonium salt compound, an azo-based metal complex, and a salicylic acid metal salt or a metal complex thereof.

The content of the charge control agent is preferably 0.01 to 30 parts by mass, and more preferably 0.1 to 10 parts by mass relative to 100 parts by mass of the binder resin.

<Release Agent>

As the release agent, various known waxes can be used. Examples of the wax include a polyolefin wax such as a polyethylene wax or a polypropylene wax; a branched chain hydrocarbon wax such as a microcrystalline wax; a long chain hydrocarbon-based wax such as a paraffin wax or a sazol wax; a dialkyl ketone-based wax such as distearyl ketone, an ester-based wax such as a carnauba wax, a montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate, or distearyl maleate; and an amide-based wax such as ethylenediamine behenylamide or trimellitic acid tristearylamide. The content of the release agent is preferably 0.1 to 30 parts by mass, and more preferably 1 to 10 parts by mass relative to 100 parts by mass of the binder resin. These compounds can be used singly or in combination of two or more kinds thereof. The melting point of the release agent is preferably 50 to 95° C. from viewpoints of low-temperature fixability and releasability of a toner in electrophotography.

<Other External Additive>

The toner according to an embodiment of the present invention may further contain another known external additive as the external additive. Examples of the external additive include inorganic oxide particles such as aluminum oxide particles and titanium oxide particles; inorganic stearic acid compound particles such as aluminum stearate particles and zinc stearate particles; and inorganic titaninc acid compound particles such as strontium titanate particles and zinc titanate particles. These inorganic particles may be subjected to gloss treatment, hydrophobic treatment, or the like with a silane coupling agent, a titanium coupling agent, a higher fatty acid, silicone oil, or the like in order to improve a heat-resistant storage property, to improve environmental stability, and the like.

Furthermore, as the other external additive, organic particles can also be used. As the organic particles, spherical organic particles having a number average primary particle diameter of about 10 to 2,000 n can be used. Specific examples of the organic particles include organic particles of a homopolymer of styrene or methyl methacrylate and organic particles of a copolymer thereof.

A lubricant can also be used as an external additive. The lubricant is used in order to further improve cleaning performance and transferability. Specific examples of the lubricant include a metal salt of a higher fatty acid, such as zinc stearate, aluminum stearate, copper stearate, magnesium stearate, calcium stearate, zinc oleate, manganese oleate, iron oleate, copper oleate, magnesium oleate, zinc palmitate, copper palmitate, magnesium palmitate, calcium palmitate, zinc linoleate, calcium linoleate, zinc ricinoleate, or calcium ricinoleate.

<Large Diameter Silica>

In the present invention, in addition to the silica particles having surfaces modified with silicone oil, it is preferable to further contain large diameter silica particles having a number average primary particle diameter of 70 to 250 nm and having an average circularity of 0.850 to 0.950 (hereinafter also referred to simply as “large diameter silica”) as an external additive. This large diameter silica may have surfaces modified with silicone oil or does not need to have surfaces modified therewith.

In a case where the particle diameter of the large diameter silica is 70 nm or more, aggregation of the toner particles due to released silicone oil can be suppressed in the presence of the large diameter silica.

In addition, in a case where the particle diameter of the large diameter silica is 250 nm or less, it is possible to suppress movement of the large diameter silica on surfaces of the toner base particles due to stress, and to avoid collision with the silica particles having surfaces modified with silicone oil.

Examples of a method for manufacturing the large diameter silica include a method for obtaining a silica sol using water glass as a raw material and a method for generating particles by a sol-gel method using a silicon compound typified by alkoxysilane as a raw material, a so-called wet method. It is particularly preferable to manufacture the large diameter silica by a sol-gel method from a viewpoint of controlling the shape of each of the silica particles. The method for manufacturing silica particles by a sol-gel method generates silica particles by causing a tetraalkoxysilane to react while supplying the tetraalkoxysilane as a raw material and an alkali catalyst as a catalyst in the presence of an alcohol containing the alkali catalyst. In addition to a catalytic action, the alkali catalyst coordinates to surfaces of core particles generated and contributes to the shapes and dispersion stability of the core particles. However, the alkali catalyst does not uniformly coat the surfaces of the core particles. Therefore, the dispersion stability of the core particles is retained, but surface tension and chemical affinity of the core particles are partly biased, and core particles with low circularity can be generated.

[Method for Manufacturing Electrostatic Latent Image Developing Toner]

A method for manufacturing the toner according to an embodiment of the present invention is not particularly limited, and examples thereof include a known method such as a kneading pulverization method, a suspension polymerization method, an emulsion aggregation method, a dissolution suspension method, a polyester elongation method, or a dispersion polymerization method.

Among these methods, the emulsion aggregation method is preferably adopted from a viewpoint of uniformity of particle diameters and controllability of the shape.

<Emulsion Aggregation Method>

The emulsion aggregation method is a method for manufacturing toner particles by mixing a dispersion of particles of a binder resin (hereinafter also referred to as “binder resin particles”) dispersed by a surfactant or a dispersion stabilizer with a dispersion of particles of a colorant (hereinafter also referred to as “colorant particles”), if necessary, aggregating the particles until a desired toner particle diameter is reached, fusing the binder resin particles, and thereby controlling the shapes. Here, the particles of the binder resin may optionally contain a release agent, a charge control agent, and the like.

As a preferable method for manufacturing the toner according to an embodiment of the present invention, an example in which toner particles having a core-shell structure are obtained by the emulsion aggregation method will be described below.

(1) Step of preparing a colorant particle dispersion in which colorant particles are dispersed in an aqueous medium

(2) Step of preparing a resin particle dispersion (core/shell resin particle dispersion) in which binder resin particles containing an internal additive if necessary are dispersed in an aqueous medium

(3) Step of mixing a colorant particle dispersion and a core resin particle dispersion to obtain an aggregation resin particle dispersion, and aggregating and fusing colorant particles and binder resin particles in the presence of a coagulant to form aggregated particles as core particles (aggregation/fusion step)

(4) Step of adding a shell resin particle dispersion containing shell layer binder resin particles to a dispersion containing core particles and aggregating and fusing the shell layer particles on surfaces of the core particles to form toner base particles having a core-shell structure (aggregation/fusion step)

(5) Step of filtering toner base particles from a dispersion of toner base particles (toner base particle dispersion) to remove a surfactant or the like (washing step)

(6) Step of drying toner base particles (drying step)

(7) Step of adding an external additive to toner base particles (external additive treatment step).

Toner particles having a core-shell structure can be obtained by firstly aggregating and fusing core particle binder resin particles and colorant particles to manufacture core particles, then adding shell layer binder resin particles to a dispersion of core particles, and aggregating and fusing shell layer binder resin particles on surfaces of the core particles to form a shell layer coating the surfaces of the core particles. However, for example, in the above step (4), toner particles formed of single-layer particles can be similarly manufactured without adding the shell resin particle dispersion.

Note that the binder resin particles containing an internal additive if necessary in the above (2) may be manufactured so as to have a multilayer structure of two or more layers. For example, in a case of manufacturing binder resin particles having a three-layer structure, the binder resin particles can be manufactured by performing a polymerization reaction for synthesizing binder resin particles in three stage consisting of a first stage polymerization (formation of an inner layer), a second stage polymerization (formation of an intermediate layer), and a third stage polymerization (formation of an outer layer). Here, by changing the composition of a polymerizable monomer in each of the polymerization reactions of the first stage polymerization to the third stage polymerization, binder resin particles having a three-layer structure, having different compositions, can be manufactured. For example, by performing a synthesis reaction of a binder resin in a state where the binder resin contains an appropriate internal additive such as a release agent in any one of the first stage polymerization to the third stage polymerization, binder resin particles having a three-layer structure, containing an appropriate internal additive, can be formed.

In this way, the toner base particles can be formed by aggregating, associating, and fusing the colorant particles and the binder resin particles such as amorphous resin particles and crystalline resin particles.

Incidentally, in the above description, the particle diameter of each of the colorant particles is preferably 80 to 200 nm in volume-based median diameter.

The particle diameter of each of the amorphous resin particles is preferably in a range of 50 to 300 nm, and more preferably in a range of 80 to 300 nm in volume-based median diameter from viewpoints of toner performance and manufacturing compatibility.

The particle diameter of each of the crystalline polyester resin particles is preferably in a range of 30 to 500 nm in volume-based median diameter, for example.

The particle diameters of the colorant particles, the amorphous resin particles, and the crystalline resin particles are measured by a dynamic light scattering method using, for example, a particle size distribution measuring instrument “Nanotrac Wave (manufactured by MicrotracBEL Corporation)”.

<External Additive Treatment Step>

For an external addition and mixing treatment of an external additive to the toner base particles, a mechanical mixing device can be used. Examples of the mechanical mixing device include a Henschel mixer, a Nauta mixer, and a turbuler mixer. Among these devices, using a mixing device capable of applying a shearing force to particles to be treated, like a Henschel mixer, it is only required to perform mixing treatment such as elongating mixing time or increasing a rotational peripheral speed of a stirring blade. In a case of using a plurality of kinds of external additives, all the external additives may be mixed at once with the toner particles, or the external additives may be mixed with the toner particles a plurality of times by dividing the external additives into a plurality of portions according to the external additives.

In a method for mixing the external additive, Si(B)/Si(A) can be controlled by adjusting the crushing degree of or the adhesion strength of the external additive by controlling mixing strength, that is, a peripheral speed of a stirring blade, mixing time, mixing temperature, and the like using the mechanical mixing device. Mixing is particularly preferably performed at a peripheral speed of 45 to 55 in/s from a viewpoint of adhesion strength.

<<Two-Component Developer>>

A two-component developer can be obtained by mixing the toner according to an embodiment of the present invention with the following carrier particles. A mixing device used for mixing is not particularly limited, and examples thereof include a Nauta mixer, a W cone, and a V-type mixer.

The content of the toner (toner concentration) in the two-component developer is not particularly limited but is preferably within a range of 4.0 to 8.0% by mass.

[Carrier Particles]

The carrier particles are formed of a magnetic material, and can also be formed of resin coating type carrier particles coated with a coating layer containing a coating resin on surfaces of core particles formed of the magnetic material, resin dispersion type carrier particles in which magnetic material fine powder is dispersed in a resin, or the like. The carrier particles are preferably formed of resin coating type carrier particles from a viewpoint of controlling true specific gravity to 4.25 to 5 g/cm³ and porosity to 8% or less. The carrier particles may contain a carrier particle internal additive such as a resistance adjusting agent, if necessary.

<Core Particles>

The core particles constituting the carrier particles are formed of, for example, various kinds of ferrites in addition to metal powder such as iron powder. Among these materials, a ferrite is preferable.

The ferrite is preferably a ferrite containing a heavy metal such as copper, zinc, nickel, or manganese, or a light metal ferrite containing an alkali metal or an alkaline earth metal.

The ferrite is a compound represented by formula: (MO)ₓ(Fe₂O₃)_{y}, and the molar ratio y of Fe₂O₃ constituting the ferrite is preferably 30 to 95 mol %. A ferrite having a composition ratio y in the above range easily obtains desired magnetization, and therefore has an advantage that a carrier hardly causing carrier adhesion can be manufactured, for example. In the above formula, M represents a metal element such as manganese (Mn), magnesium (Mg), strontium (Sr), calcium (Ca), titanium (Ti), copper (Cu), zinc (Zn), nickel (Ni), aluminum (Al), silicon (Si), zirconium (Zr), bismuth (Bi), cobalt (Co), or lithium (Li). These atoms can be used singly or in combination of a plurality of kinds thereof.

(Magnetization of Core Particles)

Saturation magnetization is preferably in a range of 30 to 75 Am²/kg, and residual magnetization is preferably 5.0 Am²/kg or less.

By using core particles having such magnetic characteristics, the carrier particles can be prevented from partially aggregating, the two-component developer is uniformly dispersed on a surface of a developer conveying member, and a uniform and high-definition toner image without unevenness in density can be formed.

<Coating Resin>

As the coating resin, a resin obtained by polymerizing an alicyclic methacrylate monomer having high hydrophobicity is preferably used. The moisture adsorption amount of the carrier particles is thereby reduced, an environmental difference of chargeability is reduced, and a decrease in the charge amount particularly under an environment of high temperature and high humidity is suppressed.

In addition, a resin obtained by polymerizing an alicyclic methacrylate monomer has appropriate mechanical strength. Therefore, in a case where the resin is used as the coating resin, a film of the resin is appropriately worn. Therefore, in a case where the resin obtained by polymerizing an alicyclic methacrylate monomer is adopted as the coating resin, surfaces of the carrier particles are suitably refreshed, and this case is preferable.

In addition, in the resin obtained by polymerizing an alicyclic methacrylate monomer, an impact generated by collision between a toner and a carrier is reduced due to presence of a cyclic alkyl group unit (=presence of a bulky portion in a part of a molecule), and therefore silica particles having surfaces modified with silicone oil do not move even when the toner and the carrier are mixed with each other. Transfer can be performed while surfaces of the toner base particles are uniformly coated with the silica particles, and therefore transferability onto an uneven sheet is improved.

As described above, the developer according to an embodiment of the present invention preferably contains an electrostatic latent image developing toner and a carrier coated with a resin formed by polymerizing at least an alicyclic methacrylate monomer.

Incidentally, the alicyclic methacrylate preferably has a cycloalkyl group having 5 to 8 carbon atoms, and specific examples thereof include cyclopentyl methacrylate, cyclohexyl methacrylate, cycloheptyl methacrylate, and cyclooctyl methacrylate. Among these compounds, cyclohexyl methacrylate is particularly preferable from a viewpoint of mechanical strength and environmental stability of a charge amount.

(Average Film Thickness of Coating Layer)

The average thickness of a coating layer in the carrier particles is preferably in a range of 0.05 to 4.0 an, and more preferably in a range of 0.2 to 3.0 μm from a viewpoint of achieving both carrier durability and reduction in electrical resistance.

By setting the average thickness of the coating layer in the above range, chargeability and durability can be set in preferable ranges.

[Electrophotographic Image Forming Method]

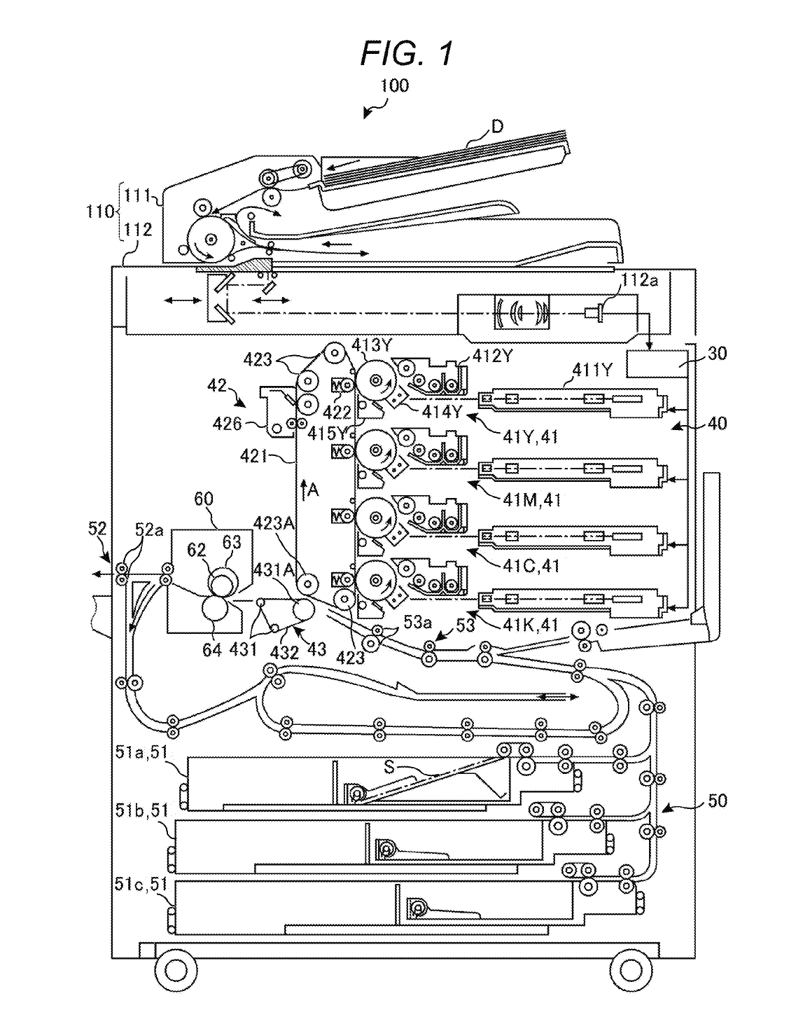

A suitable example of an image forming method using the electrostatic latent image developing toner according to an embodiment of the present invention will be described with reference to the image forming device illustrated in FIG. 1.

The electrophotographic image forming method according to an embodiment of the present invention includes at least a charging step, an exposing step, a developing step, and a transferring step using the electrostatic latent image developing toner according to an embodiment of the present invention. The transferring step includes a primary transferring step of transferring a toner image from an electrostatic latent image carrier (photosensitive drum 413) onto an intermediate transfer body (intermediate transfer belt 421) and a secondary transferring step of transferring the toner image on the intermediate transfer body onto a transfer material (sheet S).

The image forming device 100 illustrated in FIG. 1 includes an image reading unit 110, an image processing unit 30, an image forming unit 40, a sheet conveying unit 50, a fixing device 60, and the like.

The image forming unit 40 includes image forming units 41Y, 41M, 41C, and 41K for forming images using toners of yellow (Y), magenta (M), cyan (C), and black (K). These units have the same configuration except for a toner to be housed therein, and therefore symbols representing colors may be omitted below. The image forming unit 40 further includes an intermediate transfer unit 42 and a secondary transfer unit 43. These units correspond to a transfer device.

The image forming unit 41 includes an exposing device 411, a developing device 412, a photosensitive drum 413, a charging device 414, and a drum cleaning device 415.

The photosensitive drum 413 is, for example, a negatively chargeable organic photoreceptor. A surface of the photosensitive drum 413 has photoconductivity. The photosensitive drum 413 corresponds to a photoreceptor. The charging device 414 is, for example, a corona charger. The charging device 414 may be a contact charging device that charges a contact charging member such as a charging roller, a charging brush, or a charging blade in contact with the photosensitive drum 413. The exposing device 411 includes, for example, a semiconductor laser as a light source and a light deflecting device (polygon motor) that emits laser light according to an image to be formed toward the photosensitive drum 413.

The developing device 412 is a two-component developing type developing device. The developing device 412 includes, for example, a developing container that houses a two-component developer, a developing roller (magnetic roller) rotatably disposed in an opening of the developing container, a partition wall partitioning the interior of the developing container so as to make the two-component developer communicatable, a conveying roller for conveying the two-component developer on the opening side of the developing container toward the developing roller, and a stirring roller for stirring the two-component developer in the developing container. The developing container houses the toner as the two-component developer.

The intermediate transfer unit 42 includes a primary transfer roller 422 that presses the intermediate transfer belt 421 against the photosensitive drum 413, a plurality of support rollers 423 including a backup roller 423A, and a belt cleaning device 426. The intermediate transfer belt 421 is stretched in a loop shape around the plurality of support rollers 423. By rotation of at least one driving roller of the plurality of support rollers 423, the intermediate transfer belt 421 travels at a constant speed in a direction of the arrow A.

The secondary transfer unit 43 includes an endless secondary transfer belt 432 and a plurality of support rollers 431 including a secondary transfer roller 431A. The secondary transfer belt 432 is stretched in a loop shape by the secondary transfer roller 431A and the support rollers 431.

The fixing device 60 includes, for example, a fixing roller 62, an endless heat generating belt 63 for coating an outer peripheral surface of the fixing roller 62 and heating and melting a toner constituting a toner image on the sheet S, and a pressure roller 64 that presses the sheet S against the fixing roller 62 and the heat generating belt 63.

The image forming device 100 further includes an image reading unit 110, an image processing unit 30, and a sheet conveying unit 50. The image reading unit 110 includes a sheet feeding device 111 and a scanner 112. The sheet conveying unit 50 includes a sheet feeding unit 51, a sheet discharging unit 52, and a conveying path unit 53. Three sheet feeding tray units 51a to 51c constituting the sheet feeding unit 51 house the sheets S (standard sheet and special sheet) identified based on basis weight, size, and the like according to the kind set in advance. The conveying path unit 53 includes a plurality of conveying roller pairs such as a resist roller pair 53a.

An example of an image forming method using the image forming device 100 will be described.

The scanner 112 optically scans and reads a document D on a contact glass. Reflected light from the document D is read by a CCD sensor 112a and becomes input image data. The input image data is subjected to predetermined image processing in the image processing unit 30 and sent to the exposing device 411.

The photosensitive drum 413 rotates at a constant peripheral speed. The charging device 414 negatively charges a surface of the photosensitive drum 413 uniformly. In the exposing device 411, a polygon mirror of the polygon motor rotates at a high speed, laser light corresponding to input image data of each color component develops along an axial direction of the photosensitive drum 413, and an outer peripheral surface of the photosensitive drum 413 is irradiated with the laser light along the axial direction. In this way, an electrostatic latent image is formed on the surface of the photosensitive drum 413.

In the developing device 412, the toner particles are charged by stirring and conveying the two-component developer in the developing container, the two-component developer is conveyed to the developing roller, and a magnetic brush is formed on a surface of the developing roller. The charged toner particles electrostatically adhere to an electrostatic latent image portion on the photosensitive drum 413 from the magnetic brush. In this way, the electrostatic latent image on the surface of the photosensitive drum 413 is visualized, and a toner image corresponding to the electrostatic latent image is formed on the surface of the photosensitive drum 413.

The toner image on the surface of the photosensitive drum 413 is transferred onto the intermediate transfer belt 421 by the intermediate transfer unit 42. A transfer residual toner remaining on the surface of the photosensitive drum 413 after the transfer is removed by the drum cleaning device 415 having a drum cleaning blade in sliding contact with the surface of the photosensitive drum 413.

The primary transfer roller 422 presses the intermediate transfer belt 421 against the photosensitive drum 413. As a result, a primary transfer nip is formed for each photosensitive drum by the photosensitive drum 413 and the intermediate transfer belt 421. At the primary transfer nip, a toner image of each color is sequentially superposed and transferred onto the intermediate transfer belt 421.

Meanwhile, the secondary transfer roller 431A is pressed against the backup roller 423A via the intermediate transfer belt 421 and the secondary transfer belt 432. As a result, a secondary transfer nip is formed by the intermediate transfer belt 421 and the secondary transfer belt 432. The sheet S passes through the secondary transfer nip. The sheet S is conveyed to the secondary transfer nip by the sheet conveying unit 50. Correction of an inclination of the sheet S and adjustment of the timing of conveyance are performed by a resist roller unit having the resist roller pair 53a disposed therein.

When the sheet S is conveyed to the secondary transfer nip, a transfer bias is applied to the secondary transfer roller 431A. By application of this transfer bias, a toner image carried on the intermediate transfer belt 421 is transferred onto the sheet S. The sheet S onto which the toner image has been transferred is conveyed toward the fixing device 60 by the secondary transfer belt 432.

In the fixing device 60, the heat generating belt 63 and the pressure roller 64 form a fixing nip portion, and the fixing nip portion heats and presses the sheet S that has been conveyed. Toner particles constituting a toner image on the sheet S are heated, and a crystalline resin is rapidly melted inside the toner particles. As a result, the entire toner particles are quickly melted with a relatively small amount of heat, and a toner component adheres to the sheet S. In this way, the toner image is quickly fixed to the sheet S with a relatively small amount of heat. The sheet S to which the toner image has been fixed is discharged to an outside of the device by the sheet discharging unit 52 having a discharge roller 52a. In this way, a high quality image is formed.

Note that a transfer residual toner remaining on a surface of the intermediate transfer belt 421 after the secondary transfer is removed by the belt cleaning device 426 having a belt cleaning blade in sliding contact with a surface of the intermediate transfer belt 421.

Incidentally, an embodiment to which the present invention can be applied is not limited to the above-described embodiment and can be appropriately changed without departing from the gist of the present invention.

### Examples

Hereinafter, the present invention will be specifically described with reference to Examples, but the present invention is not limited thereto. Note that expression “part” or “%” used in Example means “part by mass” or “% by mass” unless otherwise specified.

<Manufacture of Silica Particles>

347.4 g of pure water was weighed and put in an Erlenmeyer flask, 110 g of tetramethoxysilane (TMOS) was added thereto under stirring, and the resulting mixture was stirred for one hour to manufacture 457.4 g of TMOS hydrolysis solution.

Subsequently, 2250 g of water and 112 g of ethylenediamine were put in a 3 liter reaction vessel equipped with a stirrer, a dropping funnel, and a thermometer and mixed. The solution was adjusted to 35° C. and the TMOS hydrolysis solution was added thereto at 2.5 mL/min under stirring.

When the addition of the TMOS hydrolysis solution was completed, the solution was kept in that state for 30 minutes, and then 4.5 g of a 1 mmol/g ethylenediamine aqueous solution was added thereto to adjust the pH to 8 to 9.

Thereafter, the remaining TMOS hydrolysis solution was added at 2.5 mL/min every three hours while an alkali catalyst (1 mmol/g ethylenediamine aqueous solution) was appropriately added so as to keep the pH 8, and this operation was continued. The TMOS hydrolysis solution was added in an amount of 457.4 g in total.

Even after the dropwise addition of the TMOS hydrolysis solution was completed, stirring was further continued for 0.5 hours to perform hydrolysis and condensation. As a result, a mixed medium dispersion of hydrophilic spherical silica particles was obtained. The particle diameter (number average primary particle diameter) of the obtained silica particles was 40 nm, and the average circularity thereof was 0.930.

Note that the number average primary particle diameter and the average circularity of the above silica particles and the following silica particles having surfaces modified with silicone oil were measured by the following methods.

(Measurement of Number Average Primary Particle Diameter)

A scanning electron microscopic image was photographed, and this photographic image was captured with a scanner. Silica particles were binarized using an image processing analyzer LUZEX AP (manufactured by Nireco Corporation) to calculate horizontal direction Feret diameters of 100 particles per one kind of silica particles, and the average value thereof was taken as a number average primary particle diameter.

(Measurement of Average Circularity)

A scanning electron microscopic image was photographed. 100 particles per one kind of silica particles were subjected to planar image analysis. Circularity was determined for each of the photographed silica particles by the following formula (3). A value obtained by averaging the circularities was taken as an average circularity.

circularity=circle−equivalent perimeter/perimeter=[2×(Aπ)^{1/2}]/PM Formula (3):

In the formula (3), PM represents the perimeter of a silica particle on an image, and A represents the projected area of a silica particle. π represents the circumference ratio. The average circularity of the silica particles is obtained as 50% circularity in a cumulative frequency of the circularities of 100 silica particles obtained by the planar image analysis.

[Surface Modification]

A solution was prepared by mixing 15 parts by mass (dimethyl silicone oil treating amount) of dimethyl silicone oil (KF-96-30cs manufactured by Shin-Etsu Chemical Co., Ltd.) with 50 parts by mass of ethanol. The resulting solution was sprayed onto the silica particles having a number average primary particle diameter of 50 nm, obtained above, to perform surface modification (hydrophobic treatment) of the silica particles. Ethanol was dried and removed at 80° C. Thereafter, surface modification (hereinafter also referred to as “silicone oil treatment”) was performed with silicone oil under stirring at 250° C. for two hours. The silica particles that had been treated with silicone oil were added again to ethanol and stirred to separate released oil. Thereafter, the silica particles were dried to obtain silica particles 1.

The particle diameter (number average primary particle diameter) of the obtained silica particles 1 was 40 nm, and the average circularity thereof was 0.83.

<Manufacture of Silica Particles 2 to 5>

Silica particles 2 to 5 were manufactured in a similar manner to the manufacture of the silica particles 1 except that the dimethyl silicone oil treating amount was changed as illustrated in Table I in the manufacture of the silica particles 1.

Note that the particle diameters (number average primary particle diameters) and the average circularities of the silica particles 2 to 5 were similar to those of the silica particles 1.

<Manufacture of Silica Particles 6>

Silica particles 6 were manufactured in a similar manner to the manufacture of the silica particles 1 except that hexamethyldisilazane (HMDS) was used instead of dimethyl silicone oil in the manufacture of the silica particles 1.

Note that the particle diameter (number average primary particle diameter) and the average circularity of the silica particles 6 were similar to those of the silica particles 1.

TABLE I

| | | | Dimethyl silicone oil |
|---|---|---|---|
| Silica particles | | Release ratio | treating amount |
| No. | Surface modifier | [%] | [parts by mass] |
| 1 | Dimethyl silicone | 55 | 15 |
| 2 | Dimethyl silicone | 32 | 10 |
| 3 | Dimethyl silicone | 67 | 19 |
| 4 | Dimethyl silicone | 80 | 26 |
| 5 | Dimethyl silicone | 15 | 5 |
| 6 | HMDS | — | — |

<Manufacture of Large Diameter Silica>

(i) To a 3 liter reaction vessel equipped with a stirrer, a dropping funnel, and a thermometer, 630 parts by mass of methanol and 90 parts by mass of water were added and mixed. To this solution, 950 parts by mass of tetramethoxysilane was added under stirring, and the resulting mixture was hydrolyzed to obtain a suspension of large diameter silica. Subsequently, the mixture was heated to 60 to 70° C. and 390 parts by mass of methanol was distilled off to obtain an aqueous suspension of large diameter silica.

(ii) To this aqueous suspension, 11.6 parts by mass (equivalent to 0.1 in terms of molar ratio with respect to tetramethoxysilane) of methyltrimethoxysilane was dropwise added at room temperature to subject a surface of the large diameter silica to hydrophobic treatment.

(iii) To the dispersion obtained in this way, 1,400 parts by mass of methyl isobutyl ketone was added, and the resulting mixture was heated to 80° C. to distill off methanol water. To the dispersion thus obtained, 280 parts by mass of hexamethyldisilazane was added at room temperature, and the resulting mixture was heated to 120° C. and caused to react for three hours to trimethylsilylate the large diameter silica. Thereafter, the solvent was distilled off under reduced pressure to prepare the large diameter silica.

The number average primary particle diameter of the large diameter silica obtained by the above method was 120 nm, and the average circularity thereof was 0.920.

<Manufacture of Titanium Oxide Particles 1>

In the present Example, titanium oxide particles 1 were manufactured as follows with reference to a method for manufacturing needle-like titanium oxide particles described in JP 2004-315356 A.

In a 3 L reaction vessel equipped with a stirrer, a dropping funnel, and a thermometer, 700 parts by mass of methanol was stirred, 450 parts by mass of titanium isopropoxide was dropwise added thereto, and stirring was continued for three minutes. Thereafter, the generated titanium oxide particles were centrifuged, separated, and collected, and then dried under reduced pressure to obtain amorphous titanium oxide.

The amorphous titanium oxide thus obtained was heated in a high temperature electric furnace at 800° C. for five hours in air to obtain rutile type titanium oxide particles.

To the above 3 L reaction vessel equipped with a stirrer, a dropping funnel, and a thermometer, 500 g of the rutile type titanium oxide particles thus obtained and 15 parts by mass of octyltrimethoxysilane were added and stirred in 2 L of toluene for 10 hours to perform hydrophobic treatment. Thereafter, the reaction product was centrifuged to wash the reaction solvent, then centrifuged again, collected, and dried under reduced pressure to obtain titanium oxide particles 1. The titanium particles had a number average long diameter of 50 nm and a number average short diameter of 10 nm.

The hydrophobilization treatment step was performed in a similar manner to the silica particles 1.

[Method for Manufacturing Toner Base Particles]

[Styrene-Acrylic (St-Ac) Resin Particle Dispersion]

(First Stage Polymerization)

Into a reaction vessel equipped with a stirrer, a temperature sensor, a cooling tube, and a nitrogen introduction device, a surfactant aqueous solution in which 4 parts by mass of an anionic surfactant containing sodium dodecyl sulfate (C₁₀H₂(OCH₂CH₂)₂SO₃Na) was dissolved in 3040 parts by mass of ion-exchanged water was put. Furthermore, a polymerization initiator solution in which 10 parts by mass of potassium persulfate (KPS) was dissolved in 400 parts by mass of ion-exchanged water was added thereto, and the liquid temperature was raised to 75° C.

Subsequently, a polymerizable monomer solution containing 532 parts by mass of styrene. 200 parts by mass of n-butylacrylic acid, 68 parts by mass of methacrylic acid, and 16.4 parts by mass of n-octylmercaptan was dropwise added thereto over one hour. After the dropwise addition, polymerization (first stage polymerization) was performed by heating and stirring the solution at 75° C. for two hours to prepare a dispersion of styrene-acrylic resin particles.

The styrene-acrylic resin particles in the dispersion had a weight average molecular weight (Mw) of 16,500.

The weight average molecular weight (Mw) of the resin was determined from a molecular weight distribution measured by gel permeation chromatography (GPC).

Specifically, a measurement sample was added to tetrahydrofuran (THF) so as to have a concentration of 1 mg/mL, dispersed for five minutes using an ultrasonic disperser at room temperature, and then treated with a membrane filter having a pore size of 0.2 μm to prepare a sample solution. Tetrahydrofuran was caused to flow as a carrier solvent at a flow rate of 0.2 mL/min while a column temperature was maintained at 40° C. using a GPC device HLC-8120GPC (manufactured by Tosoh Corporation) and column TSK guard column+TSK gel Super HZM-M triplicate (manufactured by Tosoh Corporation). Together with the carrier solvent. 10 μL of the prepared sample solution was injected into the GPC device. The sample was detected using a refractive index detector (RI detector), and a molecular weight distribution of the sample was calculated using a calibration curve created by measurement with monodispersed polystyrene standard particles. The calibration curve was created by measuring 10 types of polystyrene standard particles (manufactured by Pressure Chemical Company) having molecular weights of 6×10², 2.1×10³, 4×10³, 1.75×10⁴, 5.1×10⁴, 1.1×10⁵, 3.9×10⁵, 8.6×10⁵, 2−10⁶, and 4.48×10⁶, respectively.

(Second Stage Polymerization)

Into a flask equipped with a stirrer, a polymerizable monomer solution containing 101.1 parts by mass of styrene, 62.2 parts by mass of n-butylacrylic acid, 12.3 parts by mass of methacrylic acid, and 1.75 parts by mass of n-octylmercaptan was put. Furthermore, 93.8 parts by mass of paraffin wax HNP-57 (manufactured by Japan Wax Co., Ltd.) was added thereto as a release agent, an internal temperature was raised to 90° C. to dissolve the paraffin wax, and a monomer solution was thereby prepared.

Into a separate container, a surfactant aqueous solution in which 3 parts by mass of the anionic surfactant used in the first stage polymerization was dissolved in 1560 parts by mass of ion-exchanged water was put. The resulting solution was heated such that an internal temperature reached 98° C. To this surfactant aqueous solution, 32.8 parts by mass (in terms of solid content) of the dispersion of styrene-acrylic resin particles obtained by the first stage polymerization was added, and a monomer solution containing paraffin wax was further added thereto. The resulting solution was mixed and dispersed for eight hours using a mechanical dispersing machine CLEARMIX (manufactured by M Technique Co., Ltd.) having a circulation path to prepare a dispersion of emulsified particles (oil droplets) each having a particle diameter of 340 nm.

To this dispersion, a polymerization initiator solution in which 6 parts by mass of potassium persulfate was dissolved in 200 parts by mass of ion-exchanged water was added. This system was heated and stirred at 98° C. for 12 hours to perform polymerization (second stage polymerization), and a dispersion of styrene-acrylic resin particles was prepared.

The styrene-acrylic resin particles in the dispersion had a weight average molecular weight (Mw) of 23,000.

(Third Stage Polymerization)

To the dispersion of styrene-acryl resin particles obtained in the second stage polymerization, a polymerization initiator solution in which 5.45 parts by mass of potassium persulfate was dissolved in 220 parts by mass of ion-exchanged water was added. To this dispersion, a polymerizable monomer solution containing 293.8 parts by mass of styrene, 154.1 parts by mass of n-butylacrylic acid, and 7.08 parts by mass of n-octylmercaptan was dropwise added over one hour at a temperature of 80° C. After completion of the dropwise addition, the resulting solution was heated and stirred for two hours to perform polymerization (third stage polymerization), and then cooled to 28° C. to obtain a dispersion of styrene-acrylic resin particles.

The styrene-acrylic resin particles in the dispersion had a weight average molecular weight (Mw) of 26,800.

[Crystalline Polyester Particle Dispersion]

To a three-necked flask which had been heated and dried, 355.8 parts by mass of dodecanedioic acid as a polycarboxylic acid monomer, 254.3 parts by mass of 1,9-nonanediol as a polyhydric alcohol monomer, and 3.21 parts by mass of tin octylate as a catalyst were added. An inside of the container was evacuated by operation of reducing pressure, then replaced with nitrogen gas to make the inside an inert atmosphere, and subjected to reflux treatment at 180° C. for five hours by mechanical stirring. The temperature was gradually raised while the inert atmosphere was maintained, and stirring was performed at 200° C. for three hours to obtain a viscous liquid product. Furthermore, the molecular weight of this product was measured by GPC while air cooling was performed. When the weight average molecular weight (Mw) reached 15,000, reduction in pressure was stopped, and a polycondensation reaction was stopped to obtain a crystalline polyester resin. The crystalline polyester resin thus obtained had a melting point of 69° C.

Methyl ethyl ketone and isopropyl alcohol were added to a reaction vessel equipped with an anchor blade that gives stirring power. Furthermore, the crystalline polyester resin roughly pulverized by a hammer mill was gradually added thereto, stirred, and completely dissolved to obtain a polyester resin solution as an oil phase. Several drops of a dilute ammonia aqueous solution were added to the oil phase that had been stirred. Subsequently, the oil phase was dropwise added to ion-exchanged water to be subjected to phase inversion emulsification. Thereafter, the solvent was removed while the pressure is reduced with an evaporator. Crystalline polyester resin particles were dispersed in the reaction system. Ion-exchanged water was added to the dispersion to adjust the solid content to 20% by mass to prepare a dispersion of crystalline polyester resin particles.

The volume-based median diameter of the crystalline polyester resin particles in the dispersion was measured using a particle size distribution measuring instrument “Nanotrac Wave (manufactured by MicrotracBEL Corporation)” and found to be 173 nm.

[Preparation of Amorphous Polyester Particle Dispersion]

Into a reaction vessel equipped with a stirrer, a nitrogen introduction tube, a temperature sensor, and a rectification column, 139.5 parts by mass of terephthalic acid and 15.5 parts by mass of isophthalic acid as polycarboxylic acid monomers, and 290.4 parts by mass of 2,2-bis(4-hydroxyphenyl) propane propylene oxide 2 mol adduct (molecular weight=460) and 60.2 parts by mass of 2,2-bis(4-hydroxyphenyl) propane ethylene oxide 2 mol adduct (molecular weight 404) as polyhydric alcohol monomers were put. The temperature of the reaction system was raised to 190° C. over one hour, and it was confirmed that an inside of the reaction system was uniformly stirred. Thereafter, 3.21 parts by mass of tin octylate was added thereto as a catalyst. The temperature of the reaction system was raised from 190° C. to 240° C. over six hours while water generated was distilled off. A dehydrating condensation reaction was continued for six hours while the temperature was maintained at 240° C. to obtain an amorphous polyester resin. The amorphous polyester thus obtained had a peak molecular weight (Mp) of 12,000 and a weight average molecular weight (Mw) of 15.000.

The amorphous polyester resin thus obtained was subjected to a similar operation to that in the preparation of the dispersion of crystalline polyester resin particles, and a dispersion of amorphous polyester resin particles having a solid content of 20% by mass was thereby prepared.

The volume-based median diameter of the amorphous polyester resin particles in the dispersion was measured using a particle size distribution measuring instrument “Nanotrac Wave (manufactured by MicrotracBEL Corporation)” and found to be 216 nm.

[Colorant Particle Dispersion]

90 parts by mass of sodium dodecyl sulfate was stirred and dissolved in 1,600 parts by mass of ion-exchanged water. While this solution was stirred, 420 parts by mass of carbon black Regal 330R (manufactured by Cabot Corporation) was gradually added thereto. Subsequently, the resulting solution was dispersed using a stirrer CLEARMIX (manufactured by M Technique Co., Ltd.) to prepare a dispersion of colorant particles.

The particle diameter of each of the colorant particles in the dispersion was measured using a particle size distribution measuring instrument “Nanotrac Wave (manufactured by MicrotracBEL Corporation)” and found to be 117 nm. A method for manufacturing toner base particles includes the following steps.

[Method for Manufacturing Toner Base Particles]

Into a 5 liter stainless steel reaction vessel equipped with a stirrer, a cooling tube, and a temperature sensor, 270 parts by mass (in terms of solid content) of the styrene-acrylic resin particle dispersion as a first stage input dispersion, 270 parts by mass of the amorphous polyester resin particle dispersion (in terms of solid content), 60 parts by mass (in terms of solid content) of the crystalline polyester resin particle dispersion, and 48 parts by mass (in terms of solid content) of the colorant particle dispersion were put. Furthermore, 380 parts by mass of ion-exchanged water was put thereinto, and the pH was adjusted to 10 using a 5 (mol/liter) sodium hydroxide aqueous solution under stirring.

Under stirring, 5.0 parts by mass of a 10% by mass polyaluminum chloride aqueous solution was dropwise added thereto over 10 minutes, and the internal temperature was raised to 75° C. The particle diameter was measured using Multisizer 3 (manufactured by Beckman Coulter, aperture diameter: 50 rpm). When the average particle diameter reached 5.8 μm, a sodium chloride aqueous solution in which 160 parts by mass of sodium chloride was dissolved in 640 parts by mass of ion-exchanged water was added. Heating and stirring were continued. When the average circularity reached 0.960 using a flow type particle image measurement device FPIA-2100 (manufactured by Sysmex Corporation), the internal temperature was cooled to 25° C. at a rate of 20° C./min.

After cooling, solid-liquid separation was performed using a basket type centrifuge. The wet cake thus obtained was washed with ion-exchanged water at 35° C. with the same basket type centrifuge until the electric conductivity of the filtrate reached 5 μS/cm. Thereafter, the resulting product was transferred to a flash jet dryer (manufactured by Seishin Enterprise Co., Ltd.) and dried until the water content became 0.5% by mass.

<External Additive Treatment Step>

To the “toner base particles 1” manufactured as described above,

0.5% by mass of silica particles 1 and

0.5% by mass of large diameter silica were added. The resulting mixture was stirred with a Henschel mixer type “FM20C/I” (manufactured by Nippon Coke Industries Co., Ltd.) by setting a rotation speed such that a blade tip peripheral speed was 50 m/s for 20 minutes to prepare “toner 1” formed of the toner particles 1.

The product temperature at the time of external addition and mixing was set to 40° C.±1° C. In a case where the product temperature reached 41° C., cooling water was supplied to an outer bath of the Henschel mixer at a flow rate of 5 L/min. In a case where the product temperature reached 39° C., cooling water was supplied thereto at a flow rate of 1 L/min. In this way, the temperature inside the Henschel mixer was controlled.

Toners 2 to 16 were manufactured in a similar manner to the manufacture of the toner 1 except that the kind and amount of the external additive added in the manufacture of toner 1 were changed as illustrated in Table II.

<Method for Measuring NET Intensity (Si(A) and Si(B)) of Si Element>

Si(A) and Si(B) were calculated from a NET intensity ratio of Si by wavelength dispersive X-ray fluorescence spectroscopy before and after samples (toners 1 to 16) in a toner bottle were ultrasonically dispersed in water as follows. Results are illustrated in Table II.

(Method for Obtaining Toner Ultrasonically Dispersed in Water)

In a 100 mL plastic cup, 3 g of a sample (toner) was wetted in 40 g of a 0.2% by mass polyoxyethyl phenyl ether aqueous solution. Using an ultrasonic homogenizer “US-1200” (manufactured by Nippon Seiki Co., Ltd.), ultrasonic energy was applied to the solution for three minutes by making adjustment such that a value of an ammeter indicating a vibration indication value attached to a main body of the homogenizer indicated 60 μA (50 W). Thereafter, the aqueous solution in which the toner was dispersed was centrifuged and separated under conditions of 292 G and 10 minutes.

Used centrifuge: Model H-900 manufactured by Kokusan Co. Ltd.

Rotor: PC-400 (radius 18.1 cm)

Rotation speed: 1200 rpm (292 G)

Time: 15 minutes

After centrifugation, the supernatant was discarded. The remainder is mixed with 60 mL of pure water again, filtered using a filter having an opening of 1 μm, washed with 60 mL of pure water, and collected. The collected product is mixed with 60 mL of pure water again, filtered using a filter having an opening of 1 μm, washed with 60 mL of pure water, collected, and dried.

(Method for Measuring NET Intensity)

A method for measuring a NET intensity of Si contained in the “toner according to an embodiment of the present invention” (not ultrasonically dispersed in water) and the “toner ultrasonically dispersed in water according to an embodiment of the present invention” was as follows.

The NET intensity of a metallic element Si contained in the toner was measured as follows using a wavelength dispersive X-ray fluorescence analyzer XRF-1700 (manufactured by Shimadzu Corporation).

3 g of toner pelletized by pressurization was set in XRF-1700, and measurement was performed under measurement conditions of a tube voltage of 40 kV, a tube current of 90 mA, a scanning speed of 8 deg./min, and a step angle of 0.1 deg. For the measurement, a Kα peak angle of a metallic element to be measured was determined from a 20 Table and used.

TABLE II

| | First external additive | | Second external additive | | Blade tip | |
|---|---|---|---|---|---|---|
| | | Amount | | Amount | peripheral speed | |
| Toner No. | Kind | [% by mass] | Kind | [% by mass] | [m/s] | Si(B)/Si(A) |
| 1 | Silica particles 1 | 0.50 | Large-diameter silica | 0.5 | 50 | 0.45 |
| 2 | Silica particles 1 | 0.50 | Large-diameter silica | 0.5 | 45 | 0.31 |
| 3 | Silica particles 1 | 0.50 | Large-diameter silica | 0.5 | 55 | 0.63 |
| 4 | Silica particles 2 | 0.50 | Large-diameter silica | 0.5 | 50 | 0.45 |
| 5 | Silica particles 3 | 0.50 | Large-diameter silica | 0.5 | 50 | 0.45 |
| 6 | Silica particles 1 | 0.35 | Large-diameter silica | 0.5 | 50 | 0.50 |
| 7 | Silica particles 1 | 0.80 | Large-diameter silica | 0.5 | 50 | 0.41 |
| 8 | Silica particles 1 | 0.50 | — | | 50 | 0.64 |
| 9 | Silica particles 1 | 1.20 | Large-diameter silica | 0.5 | 50 | 0.33 |
| 10 | Silica particles 1 | 0.25 | Large-diameter silica | 0.5 | 50 | 0.63 |
| 11 | Silica particles 4 | 0.50 | Large-diameter silica | 0.5 | 50 | 0.45 |
| 12 | Silica particles 5 | 0.50 | Large-diameter silica | 0.5 | 50 | 0.45 |
| 13 | Silica particles 1 | 0.50 | Large-diameter silica | 0.5 | 40 | 0.20 |
| 14 | Silica particles 1 | 0.50 | Large-diameter silica | 0.5 | 60 | 0.80 |
| 15 | Silica particles 6 | 0.50 | Large-diameter silica | 0.5 | 50 | 0.45 |
| 16 | Titanium oxide | 0.50 | Large-diameter silica | 0.5 | 50 | 065 |
| | particles 1 | | | | | |

[Manufacture of Carrier]

(Manufacture of Carrier Core Particles 1)

Raw materials were weighed such that the content of MnO was 35 mol %, the content of MgO was 14.5 mol %, the content of Fe₂O₃ was 50 mol %, and the content of SrO was 0.5 mol %, mixed with water, and pulverized with a wet media mill for five hours to obtain slurry.

The slurry thus obtained was dried with a spray drier to obtain spherical particles. The particle sizes of the particles were adjusted. Thereafter, the particles were heated at 950° C. for two hours to be subjected to temporary firing. The particles were pulverized with a wet ball mill using stainless steel beads each having a diameter of 0.3 cm for one hour and then further pulverized for four hours using zirconia beads each having a diameter of 0.5 cm. As a binder, 0.8% by mass of PVA was added thereto relative to the solid content. Subsequently, pulverization and drying were performed with a spray drier, and the resulting product was held at a temperature of 1350° C. for five hours in an electric furnace to be subjected to main firing.

Thereafter, the resulting product was crushed and further classified to adjust the particle size. Thereafter, a low magnetic force product was separated by magnetic ore dressing to obtain carrier core particles 1. The carrier core particles 1 each had a particle diameter of 35 μm.

(Manufacture of Coating Material 1)

Cyclohexyl methacrylate and methyl methacrylate were added at a “mass ratio of 50:50” (copolymerization ratio) to a 0.3% by mass sodium benzenesulfonate aqueous solution, and 0.5% by mass of potassium persulfate relative to the total amount of monomers was added thereto to perform emulsion polymerization. The resulting product was dried by spray drying to manufacture a core material coating resin (hereinafter also referred to as “coating material”) 1. The coating material 1 thus obtained had a weight average molecular weight of 500,000.

(Manufacture of Coating Material 2)

A coating material 2 was manufactured in a similar manner to the manufacture of the coating material 1 except that only methyl methacrylate was used without using cyclohexyl methacrylate in the manufacture of the coating material 1.

(Manufacture of Carrier 1)

Into a high-speed stirring mixer equipped with a horizontal stirring blade, 100 parts by mass of the “carrier core particles 1” prepared above as core particles and 4.5 parts by mass of the “coating material 1” were put, mixed and stirred under such a condition that a peripheral speed of the horizontal rotating blade was 8 m/sec at 22° C. for 15 minutes, and then mixed at 120° C. for 50 minutes. Surfaces of the core particles were thereby coated with the coating material by an action of a mechanical impact force (mechanochemical method) to manufacture a “carrier 1”.

(Manufacture of Carrier 2)

A carrier 2 was manufactured using a coating material 2 instead of the coating material 1 in the method for manufacturing the carrier 1.

[Manufacture of Developer]

(Manufacture of Developer 1)

The toner 1 and the carrier 1 manufactured as described above were mixed with each other such that the toner concentration was 5% by mass to manufacture a developer 1. The developer 1 was evaluated as follows. Mixing was performed for 30 minutes using a V-type mixer.

(Manufacture of Developers 2 to 17)

Developers 2 to 17 were obtained by combining a toner and a carrier as illustrated in Table III in manufacture of the developer 1.

TABLE III

| Developer No. | Toner No. | Carrier No. |
|---|---|---|
| 1 | 1 | 1 |
| 2 | 2 | 1 |
| 3 | 3 | 1 |
| 4 | 4 | 1 |
| 5 | 5 | 1 |
| 6 | 1 | 2 |
| 7 | 6 | 1 |
| 8 | 7 | 1 |
| 9 | 8 | 1 |
| 10 | 9 | 1 |
| 11 | 10 | 1 |
| 12 | 11 | 1 |
| 13 | 12 | 1 |
| 14 | 13 | 1 |
| 15 | 14 | 1 |
| 16 | 15 | 1 |
| 17 | 16 | 1 |

[Evaluation Method]

As for the developers 1 to 17 thus obtained, graininess and CL performance of the developers 1 to 17 and the toners 1 to 16 were evaluated as follows.

<Graininess>

(Initial Printing: Output at Normal Printing Rate)

Using a commercially available color multifunction machine “bizhub PRO C6500” (manufactured by Konica Minolta Inc.), 1000 sheets were printed to form a belt-like solid image at a printing rate of 5% as a test image on A4-size wood free paper (65 g/m²) in an environment of low temperature and low humidity (temperature 10° C., humidity 15% RH). A gradation pattern with 32 gradation degrees was output. This gradation pattern was subjected to Fourier transformation in consideration of modulation transfer function (MTF) correction for a CCD read value. A graininess index (GI value) was measured according to human relative visibility to determine maximum graininess. A smaller GI value is better and indicates lower graininess of an image. Note that this GI value is described in the Journal of the Japan Imaging Society 39 (2), 84 93 (2000). The graininess of the gradation pattern in the image was evaluated according to the following evaluation criteria.

An image of a gradation pattern initially output was judged based on a maximum GI value (GIi) in the image according to the following criteria.

Note that evaluation of GIi was performed for the 10,001st image.

(Evaluation criteria)

⊙: GIi is less than 0.170 (allowable)

◯: GIi is 0.170 or more and less than 0.180 (allowable)

X: GIi is 0.180 or more (not allowable)

The above evaluation criteria were similarly applied also to the following “case where continuous printing was performed at a normal printing rate for a long period of time” and “case where continuous printing was performed at a low printing rate for a long period of time”.

(Case where Continuous Printing was Performed at a Normal Printing Rate for a Long Period of Time)

From the above conditions, 100,000 sheets were printed to form a belt-like solid image at a printing rate of 5% as a test image.

Note that evaluation of GIi was performed for the image of 100,001st image.

(Case where Continuous Printing was Performed at a Low Printing Rate for a Long Period of Time)

From the above conditions, 100,000 sheets were printed to form a belt-like solid image at a printing rate of 3% as a test image.

Note that evaluation of GIi was performed for the image of 100,001st image.

<CL Performance>

As an evaluation device, a commercially available digital full-color multifunction machine “bizhub PRO C6500” (manufactured by Konica Minolta Inc., “bizhub” is a registered trademark of Konica Minolta Inc.) was used. Each of the developers 1 to 17 was loaded, and evaluation was performed in an environment of high temperature and high humidity (30° C. and 80% RH).

100,000 sheets were continuously printed to form a test image with five vertical belt-like solid images with a width of 3 cm on A4 wood free paper (65 g/m²). Subsequently, after the continuous printing, a full solid image was output. The densities of five points corresponding to the belt portion after the continuous printing and six points corresponding to the non-belt portion were measured and evaluated with a maximum density difference. Judgement was made according to the following criteria. It was judged that a case of 0.09 or less was practical.

(Evaluation Criteria)

⊙: Maximum density difference is 0.03 or less (allowable)

◯: Maximum density difference is larger than 0.03 and 0.06 or less (allowable)

Δ: Maximum density difference is larger than 0.06 and 0.09 or less (allowable)

X: Maximum density difference is larger than 0.09 (not allowable)

TABLE IV

| | | Graininess | | | | | | | | |
|---|---|---|---|---|---|---|---|---|---|---|
| | | | | After long-term | | After long-term | | | | |
| | | | | printing at | | printing at | | CL performance | | |
| | | Initial | | normal | | low | | Maximum | | |
| Developer | Toner | printing | | printing rate | | printing rate | | temperature | | |
| No. | No. | GIi | Evaluation | GIi | Evaluation | GIi | Evaluation | difference | Evaluation | Note |
| 1 | 1 | 0.165 | ⊙ | 0.162 | ⊙ | 0.168 | ⊙ | 0.02 | ⊙ | Present |
| | | | | | | | | | | invention |
| 2 | 2 | 0.169 | ⊙ | 0.174 | ◯ | 0.178 | ◯ | 0.02 | ⊙ | Present |
| | | | | | | | | | | invention |
| 3 | 3 | 0.162 | ⊙ | 0.165 | ⊙ | 0.167 | ⊙ | 0.05 | ◯ | Present |
| | | | | | | | | | | invention |
| 4 | 4 | 0.173 | ◯ | 0.168 | ⊙ | 0.169 | ⊙ | 0.02 | ⊙ | Present |
| | | | | | | | | | | invention |
| 5 | 5 | 0.166 | ⊙ | 0.176 | ◯ | 0.165 | ⊙ | 0.02 | ⊙ | Present |
| | | | | | | | | | | invention |
| 6 | 1 | 0.164 | ⊙ | 0.175 | ◯ | 0.177 | ◯ | 0.02 | ⊙ | Present |
| | | | | | | | | | | invention |
| 7 | 6 | 0.164 | ⊙ | 0.174 | ◯ | 0.176 | ◯ | 0.04 | ◯ | Present |
| | | | | | | | | | | invention |
| 8 | 7 | 0.174 | ◯ | 0.164 | ⊙ | 0.168 | ⊙ | 0.02 | ⊙ | Present |
| | | | | | | | | | | invention |
| 9 | 8 | 0.174 | ◯ | 0.176 | ◯ | 0.178 | ◯ | 0.03 | ⊙ | Present |
| | | | | | | | | | | invention |
| 10 | 9 | 0.176 | ◯ | 0.177 | ◯ | 0.178 | ◯ | 0.03 | ⊙ | Present |
| | | | | | | | | | | invention |
| 11 | 10 | 0.165 | ⊙ | 0.172 | ◯ | 0.174 | ◯ | 0.09 | Δ | Present |
| | | | | | | | | | | invention |
| 12 | 11 | 0.166 | ⊙ | 0.179 | ◯ | 0.168 | ⊙ | 0.02 | ⊙ | Present |
| | | | | | | | | | | invention |
| 13 | 12 | 0.176 | ⊙ | 0.166 | ⊙ | 0.167 | ⊙ | 0.09 | Δ | Present |
| | | | | | | | | | | invention |
| 14 | 13 | 0.169 | ⊙ | 0.178 | ◯ | 0.185 | X | 0.05 | ◯ | Comparative |
| | | | | | | | | | | Example |
| 15 | 14 | 0.168 | ⊙ | 0.164 | ⊙ | 0.162 | ⊙ | 0.12 | X | Comparative |
| | | | | | | | | | | Example |
| 16 | 15 | 0.177 | ◯ | 0.185 | X | 0.189 | X | 0.15 | X | Comparative |
| | | | | | | | | | | Example |
| 17 | 16 | 0.167 | ⊙ | 0.174 | ◯ | 0.184 | X | 0.02 | ⊙ | Comparative |
| | | | | | | | | | | Example |

Table IV indicates that, according to an embodiment of the present invention, it is possible to provide an electrostatic latent image developing toner having good graininess of a printed image even after printing is performed continuously at a low printing rate and capable of suppressing cleaning failure over a long period of time.

According to an embodiment of the present invention, an exhibition mechanism or an action mechanism of an effect of the present invention is considered as follows.

Si(B)/Si(A) which is a value of a ratio between “NET intensity Si(B) of a Si element contained in the electrostatic latent image developing toner ultrasonically dispersed in water, measured by a wavelength dispersive X-ray fluorescence analyzer” and “NET intensity Si(A) of a Si element contained in the electrostatic latent image developing toner, measured by a wavelength dispersive X-ray fluorescence analyzer” represents an adhesion strength of silica particles adhering to surfaces of toner base particles. That is, in proportion to the magnitude of Si(B)/Si(A), the adhesion strength of the silica particles adhering to surfaces of the toner base particles increases.

The present inventors have found that if the Si(B)/Si(A) is 0.30 or more (adhesion strength is not too low), the silica particles hardly move on surfaces of the toner base particles, and therefore movement or collision of the silica particles on the surfaces of the toner base particles due to stress is suppressed. Furthermore, the present inventors have found that if the Si(B)/Si(A) is 0.30 or more, aggregation of the toner particles due to movement of released silicone oil present in the silica particles having surfaces modified with silicone oil to surface of other silica particles such as silica particles having surfaces not modified with silicone oil or the toner base particles is reduced and good graininess of a printed image is obtained even after printing is performed continuously at a low printing rate. In addition, the present inventors have also found that if the Si(B)/Si(A) is 0.65 or less (adhesion strength is not too high), a function as silica particles including silica particles having surfaces modified with silicone oil can be exhibited because of the silica particles present in a state not buried in the surfaces of toner base particles, and as a result, wear of a cleaning blade is suppressed, leading to suppression of occurrence of cleaning failure over a long period of time.

In addition, when surfaces of the silica particles are modified with silicone oil, it is possible to uniformly modify the surfaces. As a result, in the present invention, when silicone oil is released from surfaces of silica particles, surfaces of silica particles having surfaces not modified with silicone oil are not exposed. Therefore, it is presumed that distribution of a charge amount does not spread and graininess is improved.

Although embodiments of the present invention have been described and illustrated in detail, the disclosed embodiments are made for purposes of illustration and example only and not limitation. The scope of the present invention should be interpreted by terms of the appended claims.

What is claimed is:

1. An electrostatic latent image developing toner comprising toner particles having silica particles as an external additive on surfaces of toner base particles, wherein
surfaces of a part or all of the silica particles are modified with silicone oil, and
the following relational formula (1) is satisfied.
0.30≤Si(B)/Si(A)≤0.65 relational formula (1)
[In the relational formula (1), Si(A) represents a NET intensity of a Si element contained in the electrostatic latent image developing toner, measured by a wavelength dispersive X-ray fluorescence analyzer. Si(B) represents a NET intensity of a Si element contained in the electrostatic latent image developing toner ultrasonically dispersed in water, measured by a wavelength dispersive X-ray fluorescence analyzer.]

2. The electrostatic latent image developing toner according to claim 1, wherein the Si(A) and the Si(B) satisfy the following relational formula (2).
0.35≤Si(B)/Si(A)≤0.60 relational formula (2)

3. The electrostatic latent image developing toner according to claim 1, wherein a content of the silica particles having surfaces modified with the silicone oil is in a range of 0.3 to 1.0% by mass relative to 100% by mass of the electrostatic latent image developing toner.

4. The electrostatic latent image developing toner according to claim 1, wherein a release ratio of the silicone oil from the silica particles is in a range of 30 to 70% by mass.

5. A two-component developer comprising:
the electrostatic latent image developing toner according to claim 1; and
a carrier coated with a resin formed by polymerizing at least an alicyclic methacrylate monomer.
